(19) United States
(12) Patent Application Publication
(10) Pub. No.: US 2024/0010888 A1
(43) Pub. Date: Jan. 11, 2024

(54) Dual-Cure Mechanism Polymeric Adhesives

(71) Applicant: Zephyros, Inc., Romeo, MI (US)

(72) Inventors: Michael Czaplicki, Romeo, MI (US); Ethan Post, Romeo, MI (US)

(21) Appl. No.: 18/033,295

(22) PCT Filed: Oct. 8, 2021
(86) PCT No.: PCT/US2021/054100

§ 371 Date: Apr. 21, 2023

Related U.S. Application Data
(60) Provisional application No. 63/104,987, filed on Oct. 23, 2020.

(51) Int. Cl. C09J 163/00

(52) U.S. Cl. CPC C09J 163/00

(57) ABSTRACT

A two-component dual-cure adhesive having a first component and a second component that partially react when mixed to provide some adhesive strength plus processing capability and further reacts upon exposure to a secondary stimulus to produce a high strength adhesive.

### FIELD OF INVENTION

The present teachings relate generally to two component adhesives. More particularly, the present teachings relate to an adhesive having a two-stage activation.

### BACKGROUND

One component adhesive systems struggle with shorter than desirable shelf lives, due to curing agents and other reactants being compounded together, and this is particularly true as the cure temperature is reduced. Furthermore, there is difficulty in dispensing because high viscosity is required to prevent wash-off before curing. Two component adhesives can be superior to one-component adhesives for reasons including longer shelf life by separating the curing reagent(s) from the other reactants, and lower viscosity for dispensing. Two component adhesives still present certain challenges during mixing and application. Slow cure times and low filler content contribute to low viscosity for ease in dispensing and preventing applicator clogging by premature gelation, but results in reduced wash-off resistance, whereas faster cure times can also negatively affect adhesion and adhesion durability. As discussed in this teaching, the cure rate of two component adhesives is important in balancing the viscosity such that the viscosity does not build in the mix nozzle to the extent that it prevents subsequent dispensing in manufacturing, while still gaining molecular weight quickly enough to prevent wash-off in later assembly processes.

There is a particular utility for adhesives that can react quickly to create a unitized assembly that can then be subjected to heat or other secondary stimulus exposure that will enable the adhesive to develop full properties. Such an adhesive can be useful for minimizing distortion between adhered substrates due to partial compliance of the adhesive upon heating. This is the case particularly for assemblies using dissimilar material composition. In addition, this enables an approach of having minimal fixturing time and/or the elimination of weldments and/or mechanical fasteners that are used typically for structure stabilization for both slow reacting two component materials and single component materials that react via a secondary stimulus. Staged curing in prior work has been used to for various purposes. U.S. Pat. No. 5,997,682 utilizes an electron beam to perform an initial radiation cure on a urethane acrylate and polyurethane chemistry system followed by a slow ambient curing of up to 72 hours. This yielded an elastomeric, phase-separated adhesive capable of bonding heat sensitive materials. The slow ambient curing in the second stage makes up for shadowing that prevents the electron beam from fully curing the material in assembly. The high cost and safety concerns of using electron beam curing are not preferred, and ambient cured adhesives are typically much weaker than heat cured materials, especially for structural adhesives. U.S. Pat. No. 8,382,929 utilizes a 24-hour ambient free radical polymerization, which left a tacky adhesive surface due to oxygen inhibition, followed by a UV initiated photopolymerization to complete the cure. The second stage overcomes the challenge of oxygen inhibition in free radical chemistry, but the initial reaction is again slow and the tacky surface could create handling and contamination concerns in manufacturing. U.S. Pat. No. 8,491,749 combines a reactive liquid modifier and epoxy system to form an interpenetrating network in a dual heat cured process. To obtain the strong and tough adhesive, the first heat cure at 110° C. must polymerize the reactive modifier and the second heat cure at 180° C. reacts the epoxy system. A curing process using two different ovens is undesirable due to cost and time.

The present teachings solve one or more of these challenges by providing for a liquid or paste two-component, polymeric adhesive that: reacts to create a higher molecular weight material up to a solid capable of supporting load and maintaining structure stability upon mixing at room temperature; reacts in an agreeable time frame; provides some initial adhesive strength or processing advantage; and subsequently cross-links or chain extends to become a higher molecular weight high polymer under secondary, external stimulus, such as heat, to alter physical properties. The ambient cured fraction could be thermoplastic or moderately crosslinked, while the final adhesive will be a fully crosslinked thermoset or very high molecular weight thermoplastic. The processing advantages to a dual-cured system include low initial viscosity for ease of dispensing and application, wash-off resistance before final curing, decreased substrate and bond line distortion from dissimilar substrate bonding, prevention of substrate pillowing during mechanical fastening or welding, and decreased mechanical fastening of components before final adhesive curing.

### SUMMARY OF INVENTION

The teachings herein are directed to a two-component dual-cure adhesive having a first component and a second component that partially react when mixed to provide some adhesive strength plus processing capability and further reacts upon exposure to a secondary stimulus to produce a high strength adhesive.

The secondary stimulus may be heat. Only one of the first or second component may include only one type of a reactive group to react with an ambient curative and a secondary latent curative. Both first and second components may include complementary reactive species. The first component and second component may include reactive species that form an interpenetrating network (IPN). The first component may include an epoxy and the second component may include one or more of an amine, an amine derivative, a polyamide, an anhydride, a phenol, an imidazole, a phosphate ester or phosphoric acid, a mercaptan, or a mercaptan derivative. At least one of the first or second component may include two or more reactive groups to react with both an ambient curative and a latent curative. The first component may comprise both epoxy and acrylate and the second component may include one or more of an amine, an amine derivative, a polyamide, an anhydride, a phenol, an imidazole, a phosphate ester or phosphoric acid, a mercaptan, or a mercaptan derivative.

An ambient curative may form a thermoplastic after mixing the first and second components. An ambient curative may form a partial thermoset after mixing the first and second components. A latent curative may form a thermoplastic after exposing the adhesive to a stimulus. A latent curative may form a thermoset after exposing the adhesive to a stimulus. The addition of an ambient curing agent may decrease the extent of warping or deflection in final bonded dissimilar substrates after exposure to a stimulus due to coefficient of thermal expansion mismatch. Increasing levels of an ambient curing agent in the cure package may decrease warpage of the final bonded dissimilar substrates. The dual cure of the adhesive may substantially prevent bond line separation of dissimilar substrates if allowed to remain at room temperature prior to exposure to a stimulus. Increasing levels of an ambient cure fraction may increase a developed green state lap shear strength and also increases the holding ability, to minimize the number of fasteners required to hold a part in position pre-cure.

A first-stage, ambient cure may not react to a degree such that it prevents proper wet out and/or complete cure. There may be an optimum percentage of ambient curing agent between 5 and 50% of the stoichiometric ratio, or even between 15-30%, of the total cure equivalents to fully react the adhesive. An amount of ambient curing agent below about 5% may substantially prevent one or more adhesive properties from developing. An amount of ambient curing agent above about 50% has a deleterious effect on one or more adhesive properties following the subsequent curing step. An ambient curing fraction of the material may create one or more of wash-off resistance and the prevention of pillowing during welding, while maintaining the integrity of the bonded structure until it is cured fully.

### DESCRIPTION OF THE DRAWINGS

FIG. 1 shows a chart depicting maximum deflection of bonded 1″×12″ aluminum and steel coupon assemblies due to mismatch of coefficients of thermal expansion of various example formulations.

FIG. 2 shows a close-up view of a bond line between aluminum and steel substrates and an exemplary formulation (Example A, 30 min ambient before secondary cure) of the teachings herein.

FIG. 3 shows a close-up view of a bond line between aluminum and steel substrates and an exemplary formulation (Example A, 1 h ambient before secondary cure) of the teachings herein.

FIG. 4 shows a close-up view of a bond line between aluminum and steel substrates and an exemplary formulation (Example B, 30 min ambient before secondary cure) of the teachings herein.

FIG. 5 shows a close-up view of a bond line between aluminum and steel substrates and an exemplary formulation (Example B, 1 h ambient before secondary cure) of the teachings herein.

FIG. 6 shows a close-up view of a bond line between aluminum and steel substrates and an exemplary formulation (Example C, 30 min ambient before secondary cure) of the teachings herein.

FIG. 7 shows a close-up view of a bond line between aluminum and steel substrates and an exemplary formulation (Example C, 1 h ambient before secondary cure) of the teachings herein.

FIG. 8 shows a close-up view of bond line separation between aluminum and steel substrates and an adhesive (Example A, no ambient time before secondary cure) for comparative purposes.

FIG. 9 shows a close-up view of bond line separation between aluminum and steel substrates and an adhesive (Example B, no ambient time before secondary cure) for comparative purposes.

FIG. 10 shows a close-up view of bond line separation between aluminum and steel substrates and an adhesive (Example C, no ambient time before secondary cure) for comparative purposes.

FIG. 11 shows a close-up view of bond line separation between aluminum and steel substrates and an adhesive (1K epoxy with no ambient curing agent) for comparative purposes.

FIG. 12 shows a close-up view of bond line separation between aluminum and steel substrates and an adhesive (additional 1K epoxy with no ambient curing agent) for comparative purposes.

FIG. 13 shows a close-up view of bond line separation between aluminum and steel substrates and an adhesive (Example D with no ambient curing agent) for comparative purposes.

FIG. 14 shows a chart depicting green state lap shear strength of exemplary adhesives (Examples A, B, & C) located between steel and aluminum substrates.

FIG. 15 shows a chart depicting final T-peel strength of exemplary adhesives (Examples A, B, & C) located between steel and aluminum substrates.

FIG. 16 shows a chart depicting final 23° C. wedge impact peel of exemplary adhesives (Examples A, B, & C) located on a substrate.

FIG. 17 shows a chart depicting final lap shear strength after the secondary cure of exemplary adhesives (Examples A, B, & C) located between steel and aluminum substrates.

### DETAILED DESCRIPTION OF THE INVENTION

The explanations and illustrations presented herein are intended to acquaint others skilled in the art with the invention, its principles, and its practical application. Accordingly, the specific embodiments of the present disclosure as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein are directed to the use of complementary reactive functionalities of low molecular weight monomers or oligomers in parts A and B of a two-component system to create higher molecular weight molecules upon mixing and subsequent reaction of the two material sides. Each side of A or B will contain at least a single constituent capable of reacting with a corresponding component from the other side of the composition to create a higher molecular weight typically copolymeric material (e.g., having a molecular weight that is higher than either part A or part B). More than one monomer of a particular type, or reactive functionality, may be present in either or both sides of the reactive composition to create more complex terpolymers or other higher order multi-monomer-containing polymeric materials. In general, one side of the two-component mixture may have excessive reactive functionality such that remaining non-reacted functionality could react to produce a second event within the composition when exposed to higher temperatures or some other type of stimulus to create a higher molecular weight and/or cross-linked material as a result of the second reaction. Alternatively, a reactive functionality could be created as a result of the reaction of selected monomers and oligomers for the purposes of enabling a secondary reaction. It is quite possible that one of the two sides should have at least one reactive constituent that is reactive with another part of the two-component composition at ambient temperatures. Further, at least one second constituent that is not reactive, or minimally reactive, at ambient temperatures with the reactive functionality of the first part, should be reactive with residual reactive functionality of the second part or some other part of the resultant polymeric construction (that may have been produced during the initial advancement following the ambient temperature reaction). This type of system can also include interpenetrating networks (IPNs) or orthogonally cross-linkable materials to obtain distinctive dual-curing structures. It is also possible that constituents can be utilized to generate radicals that initiate chain-growth polymerization. The two most common classes of initiators are peroxide and azo compounds.

One specific non-limiting example of this approach is to have one side with at least one epoxide containing monomeric material, and a second side containing at least one reactive hydrogen selected from an amine, amine derivative, thiol or thiol derivative, to produce the initial increased molecular weight composition. This reaction may be followed by a secondary reaction with a latent epoxide curative such as dicyandiamide, an imidazole, acid anhydride or other latent curative. In such an example, the two-component composition may be chosen such that there would be stoichiometric excess of epoxide functional material as compared to the amine or thiol to enable an epoxide functionality excess available for secondary reaction with the latent curative. Because the latent curative is not highly reactive without a secondary stimulus (for example elevated temperature exposure), it is possible that the latent curative could be in the side containing the epoxide functionality or the side containing reactive hydrogens. However, in an effort to extend the shelf life of the components prior to reaction, it may be preferable for the latent curative to be in the non-epoxide containing side.

While the choice of appropriate reactive functionalities to make the system work properly is important, many ingredients that may or may not participate in one of the reactions can be added to either side of the two-component composition to alter the polymerized composition physical properties, adhesive capability, adhesion durability, or rheology of the un-reacted components, or other characteristics. Common potential ingredients include fillers, rheology additives, impact modifiers, plasticizers, fibers, pigments, moisture scavengers, reaction accelerators or retarders, etc. Fillers are organic or non-organic additives which differ from the polymeric matrix to improve adhesive properties, change thixotropic properties, reduce cost, and lower thermal expansion and curing exotherm. These include: silicates such as those sold under the trade names of Garamite® and Satintone® clays, mica, talc, clays, wollastonite under the trade names of Nyglos®, Vansil® and Wollastocoat®, calcium carbonate, calcium oxide, calcium sulfate, fumed silica under trade names of Aerosil® and Cab-o-sil®, hollow glass and polymer spheres, carbon black, and graphite.

Fibers may be used to improve the mechanical properties of the adhesive or alter rheology. Fiber composition, coating, diameter, length and presence or absence of fibrillation can be controlled to alter performance and for processability. Greater ultimate strength, fracture toughness, and rigidity can be achieved when fibers are well-incorporated into the polymer matrix. Glass fiber is a common example, while carbon fiber, aramid fiber, and fibrous minerals may also be utilized.

Pigments may be utilized that are finely ground solid colorants and are dispersed in a polymer system for coloration which is more colorfast and migration resistant than dyes. Non-particulate pigments and dyes may be used as well, especially those capable of reacting into the formulated system. These may be organic or inorganic in nature and may include one or more of iron oxides, titanium dioxide, zinc oxide, carbon black, chromium (III) oxide, phthalocyanines, diarylides, naphthols, and other azo pigments.

Rheology additives may also be utilized to alter adhesive viscosity to meet the demands of processing and application. Increasing adhesive viscosity with a thixotropic agent, such as the previously mentioned silica or nanoclays, provides a higher viscosity adhesive that will be flow resistant after application to a substrate and enables thicker bond lines to be produced, but is simultaneously shear thinning to aid in pumping and application. Higher viscosities at low shear rates also enhance product storage stability. BYK provides a wide range of fillers and rheology additives to complement a variety of solvent systems, filler types, and component polarities including but not limited to BYK-405, BYK-430, BYK-7411 ES, BYK-R 605, and the Claytone product line. Materials having a lower viscosity may be desirable for greater penetration in casting or wetting out a substrate. Additionally, it may be desirable to increase or decrease viscosities in two-component adhesives to achieve similar viscosity between parts A and B for efficient, accurate, and more thorough mixing during application. In an effort to reduce adhesive viscosity, low viscosity reactive diluents may be incorporated. For epoxy systems, mono-, di-, and multi-functional glycidyl derivatives are very common, such as the Erisys® product line or Cardolite® products. These include butyl glycidyl ether, C8-C14 alkyl glycidyl ethers, aromatic glycidyl ethers, glycol diglycidyl ethers, glycidyl ethers of aliphatic diols, and glycidyl esters of carboxylic acids. Diluents from natural products can also be used such as cashew nutshell liquid (CNSL), castor oil, soybean oil, linseed oil, or their derivatives. Mono-, di-, and multi-functional methacrylate and acrylate polymers, including Sartomer™ and Miramer™ products, are also compatible in epoxy systems for imbuing unique adhesive properties, and changes in reactivity, with low, uncured viscosity.

Strategic use of curing agents and chain extenders can also be unconventional yet effective rheology modifiers in two-component, dual-curing systems. The reactive species incorporated will be largely dictated by curing needs in both stages, but their viscosity contribution can be beneficial in preventing adhesive wash-off as the initial reaction proceeds in the first curing stage of this teaching. These include di- and multi-functional mercaptans such as the Capcure® and Gabepro® products from Gabriel Performance Products and Thiocure® products from Bruno Bock which allow for thiol-ene chemistry, polysulfides such as Thiokol™ and Thioplast®, phosphate esters, and amines, polyamines and polyamides (e.g. Ancamine® and Ancamide® from Evonik Industries).

Plasticizers are non-reactive constituents that reduce the glass transition temperature and impart flexibility to adhesive. However, plasticizers may migrate from the adhesive and may degrade final properties. These can include low levels of solvent, phthalates, adipates, phosphate esters, glycol ether-esters, natural oils and fatty acids, indene, styrene, and phenols.

Toughening agents (i.e. ingredients to improve fracture toughness, or impact resistance) and/or flexibilizers (typically elastic modulus reducing constituents) may be included when impact strength and improved properties at low temperatures are required. The use of flexibilizers may further assist retaining the other mechanical properties of the non-toughened, rigid system. Flexibilizers may be used to help absorb or dissipate energy and/or prevent crack propagation, or increase strain-to-failure of the final composition. They may also aid in reducing internal adhesive stresses during cure and/or assist in damping the effects of thermal cycling, especially in systems with dissimilar material bonding. The flexibilizers may comprise lower modulus elastomeric materials having glass transition temperatures typically below −30° C. Tougheners may be solubilized and later phase separate into microphases. They may be additives which may be dispersed core-shell rubber (CSR) particles. The solubilized toughening agents commonly react into the final adhesive and may include materials such as Hypro® liquid rubber (carboxyl-terminated butadiene-acrylonitrile copolymer, epoxy-terminated butadiene-acrylonitrile copolymer, or amine-terminated butadiene-acrylonitrile copolymer) adducts, liquid polysulfide polymers such as Thiokol™ and Thioplast®, polyetheramines such as the Jeffamine® product line, certain polyamides such as Versamid®, and functional dimer fatty acids and their adducts including Hypox® from Emerald Performance Materials® and Unidyme™ from Kraton™. Additional suitable toughening agents include glycidyl dimer esters (e.g. Erisys® GS-120), polyester adducts, phenol terminated urethane prepolymer derivatives, and polyether urethanes formed from polyether polyols as the soft, flexible segment and a diisocyanate.

A moisture-scavenging component may be added to remove water from the adhesive system so that it no longer plasticizes and degrades the mechanical properties of the bond. The scavenger may either adsorb water or react with it. There are many grades of zeolite desiccants or molecular sieves available which adsorb water. Oxazolidines, silanes (e.g. vinyltrimethoxy silane), and calcium oxide react with water to remove it. Beyond removing water, additives that inhibit water uptake can be incorporated in the formula. Hydrophobic diluents with hydrocarbon chains, such as several Cardolite® products, may improve adhesive performance after humidity and submersion testing.

Reaction accelerators and/or retarders may be used to control the rate and conditions at which the curing reaction can take place. It is possible that such accelerators and/or retarders are selected to promote effective application and/or improve bonding properties. Slower, lower temperature curing may be associated with decreased material shrinkage and less internal stress in the final bond. Accelerators may be utilized to increase reaction rate (e.g., to decrease cure time) at a given temperature or to allow the reaction to take place at a lower temperature than it normally would. Retarders may be utilized when the reaction is too vigorous, extended pot life is desired, and/or it is desired that an exotherm be controlled to prevent charring of the material or damage to a substrate. Different classes of hardeners cure at various rates and may be selected based on its behavior when combined with one or more of an accelerator or retarder. To slow a reaction, compounds can be added which react competitively with the main curing chemistry to slow gelation, have molecular interactions, such as hydrogen bonding, with reactive sites to inhibit the reaction, or by decreasing the number of functional groups per unit volume. These compounds may include reactive diluents that compete in the gelation reaction or low levels of solvent such as acetone. Furthermore, fillers may aid in reducing the reaction exotherm by either the dilution effect or by increasing the thermal conductivity (e.g. aluminum powder) of the adhesive. For epoxy systems, some accelerators that may be utilized are aliphatic polyamines, bis-ureas, tertiary amines, phenols, triphenyl phosphite, acids, hydroxyamines, and imidazoles.

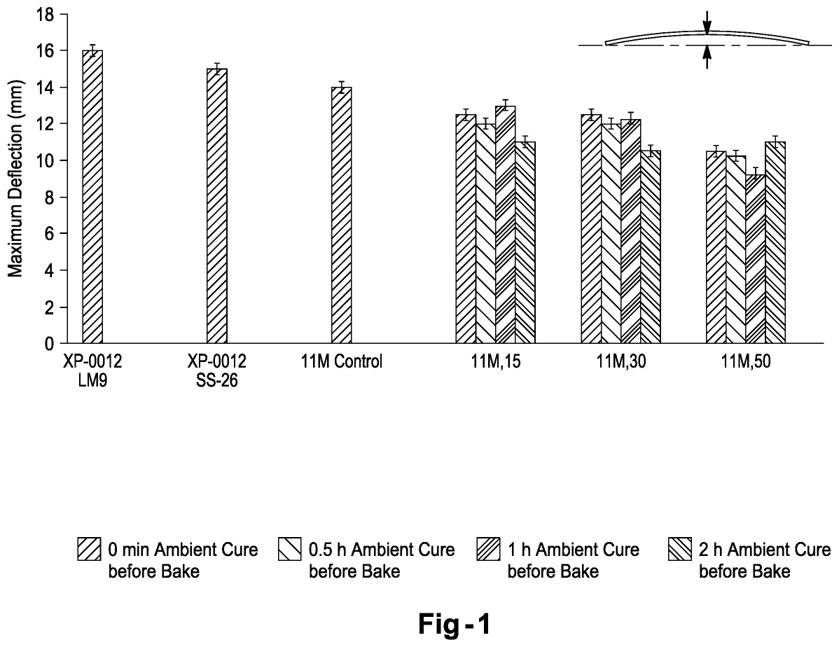

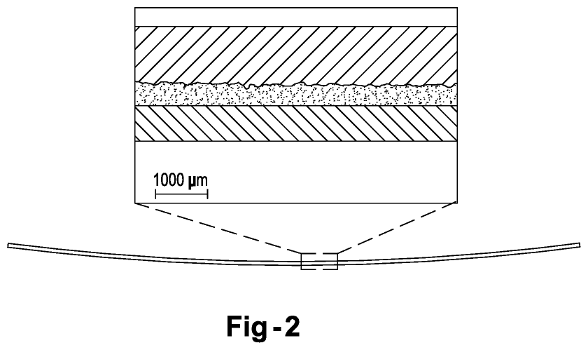

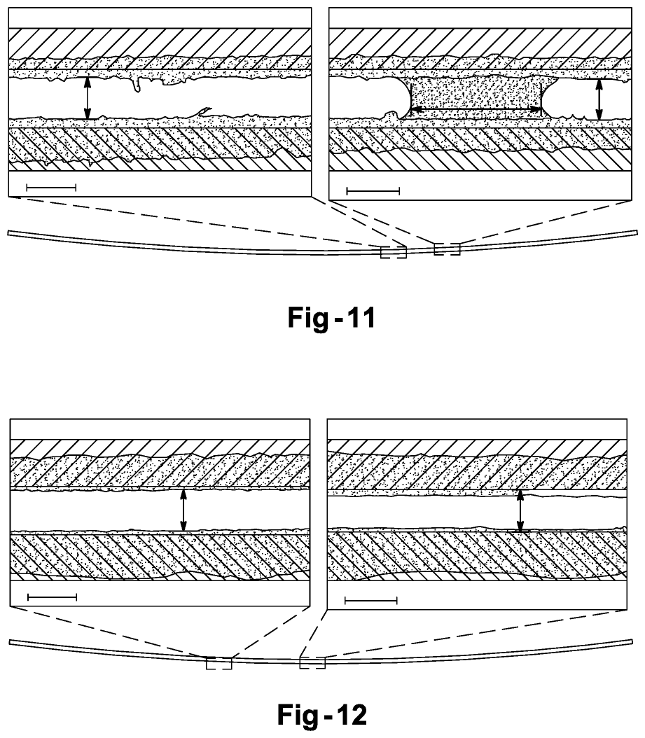

The first component of the two-part system may comprise reactive monomeric, oligomeric or polymeric constituents, tougheners, and fillers, while the second component may comprise, at a minimum, a curative, an accelerator, and a latent curative. Upon mixing, room temperature advancement may occur by the curative, and subsequent heating fully cross-links the adhesive through the separate latent curative. It is possible that the first stage cure or reaction is not to an extent as to fully set the system (which may inhibit full cure in the second stage of this dual-cure system). The practice of not reacting the composition to a great extent in the first stage has been shown to be important in maintaining the ability to obtain desirable properties following the second cure stage. As such, there is a balance to be obtained through limiting the extent of reaction in the first stage to produce adequate first stage mechanical properties while maintaining the ability to obtain a desired property set following the second curing stage. The advancement mechanism and chemistry are such that distortion upon secondary cure is reduced, especially in the event of coefficient of thermal expansion mismatch between substrates. This helps solve a universal problem of dissimilar bonding where, upon heating, one material in an assembly expands more than the other, bonds together at the elevated temperature, ands warps on contraction while cooling back down. This is because the bond forms at the altered dimensions and tries to lock the assembly in that configuration via its molecular configuration at the time of gellation, but the dissimilar materials cool back down near to their original dimensions. As one material contracts more than the other, it bends the assembly inward in the direction of the substrate with the higher coefficient of thermal expansion, which is a concave shape for our 1″×12″ steel to aluminum assemblies (see inset of FIG. 1). Because the material of this teaching may begin cross-linking at room temperature or shortly after the application of a heating cycle, there is the ability to reduce distortion between mating substrates such as steel to aluminum (see for example FIG. 1). This is seen whether the bonded material remains at room temperature for 0 min, 0.5 h, 1 h or 2 h before heat curing. Increased percentages of ambient curing agent in the cure package may further decrease warpage of the final bonded, dissimilar metal coupons for a given ambient curing time. This is demonstrated in FIG. 1 by the higher deflection of the bonded coupons with samples using no ambient curing agent (XP-0012 LM9, XP-0012 SS-26 and 11M,0) versus the samples using increasing percentages of ambient curing agent (15, 30 and 50%). Still, there may be a point where the ambient cure period is long enough that the lower ambient curing agent percentages will see similar results in reduced distortion, such as the 2 h ambient cure times in FIG. 1. If the material is lightly cross-linked at room temperature, this creates the possibility of having the room temperature position of the substrates be the condition of zero thermal distortion between substrates. Therefore, this is a useful tool to decrease distortion between mating substrates of differing composition, and by extension differing coefficient of thermal expansion, after curing at elevated temperature and returning to room temperature. Additionally, the ambient curing fraction prevents bond line separation during the final, heated cure that often occurs due to coefficient of thermal expansion mismatch and/or material flow from the bond line at elevated temperature. The strength developed at room temperature holds the metal coupons together and prevents flow of the adhesive from the bond line, as shown by no voids in the adhesive of FIGS. 2 to 7. These 1″×12″ coupons were cured with only the ends clamped during the cure cycle, and the clamps were removed during the cooling period. Dual cure adhesives that are oven cured directly after application, with no time for ambient cure (see FIGS. 8 to 10), or one-part analogous materials (see FIGS. 11 to 13) see gap formation in the bond line.

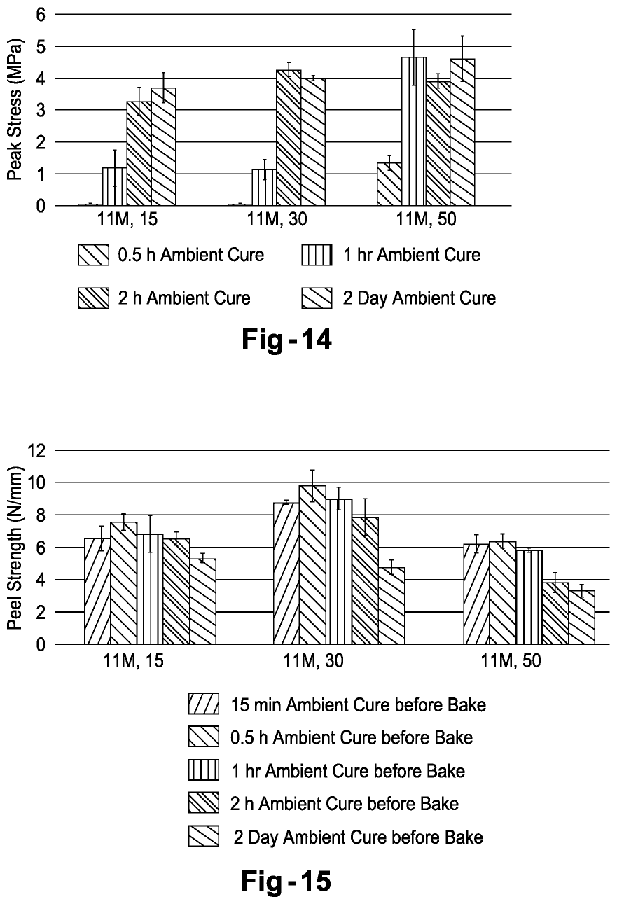

There are also several processing advantages to this dual-cured adhesive approach. The viscosity of the two-component system is such that it may be applied at low temperature, without the need for heated lines, and can be readily purged when necessary. Lower viscosity materials are possible because with two component materials, there is not the need for the viscosity to be high enough to prevent wash-off for adhesives used in structures that will undergo the E-coat process. With the dual-cure approach, viscosity build via molecular weight advancement takes the place of increased viscosity to prevent wash-off. The low viscosity material may readily wet out and displace or solubilize surface contaminants for enhanced adhesion. Within the first hour, the initial cure provides for wash-off resistance and decreased need of mechanical fasteners before the full cure. Increasing levels of ambient cure fraction is shown to increase the developed green state lap shear strength (see FIG. 14) and the holding ability, to enable the possibility of minimizing or even eliminating the number of fasteners required to hold a part in position prior to elevated temperature exposure. One possible application of this dual-curing system is that a component assembly can be formed having undergone only the ambient first stage curing, and then shipped to a final assembly location for final curing, without damage to the assembly from a typical mode of adhesive failure. Despite the benefits of a high percentage of ambient curing agent, it is possible that the ambient curing agent and the latent curative be well balanced in this type of dual curing adhesive system for forming a strong and tough structural adhesive. There may be an optimum level of ambient cure fraction between 5 and 50%, preferably 15-30%, of the total cure equivalents to fully react the complementary component, as demonstrated in FIGS. 15 to 17. Too little ambient curing agent may prevent the desired physical properties from developing such as lap shear, T-peel, and wedge impact properties prior to final heat activation, while too much ambient curing agent may harm final properties, especially wedge impact resistance. Allowing the adhesive to cure at ambient conditions too long may also harm the final properties, particularly T-peel with a 2-day ambient time period as shown in FIG. 15.

An additional motivation is avoidance of the use of weldments in conjunction with structural bonding materials. Today, it is often the case that single component structural bonding materials are applied in a weld seam and then spot welds are made through the adhesive. It is known that in some instances the combination of the weld with the adhesive performs not as well as the adhesive alone, particularly for resistance to environmental exposure conditions, as welding can locally damage the metal's corrosion protection and the adhesive itself. A dual cured system offers the opportunity to use the initial state of cure for fixturing while using temporary fixturing until sufficient initial properties have been developed, something that is not possible with single component heat activated structural bonding materials today. This approach thereby creates the possibility of achieving superior performance as compared to combined bonded and welded seams.

For a fine-tuned final adhesive formulation to be used in structural bonding, it must meet certain cured physical properties. The typical properties for a crash-durable structural adhesive on rigid substrates such as steel include a lap shear peak stress of >25 MPa, a wedge impact peel strength at 23° C. of >35 N/mm, and a wedge impact peel strength at −40° C. of >20 N/mm. For only a semi-crash durable adhesive, the lap shear peak stress may be >22 MPa with a wedge impact peel strength at 23° C. of >15 N/mm and a wedge impact peel strength at −40° C. of >8 N/mm (High-Performing Adhesive Bonding Fastening Technique For Automotive Body Structures by Detlef Symietz and Andreas Lutz). Furthermore, it may be desired that the formulation maintain a high percentage of its initial lap shear strength after a 21-day salt spray exposure. An example of a commercial structural adhesive showed a steel to aluminum lap shear peak stress of 42 MPa and 34.4 Mpa after 21 day salt spray (82% property retention), an 8.9 N/mm T-Peel strength, a wedge impact peel strength at 23° C. of 30.1 N/mm, and a wedge impact peel strength at −40° C. of 21.4 N/mm. The current state of the teachings herein if considering Example B (11M,30 cured for 1 h ambient before a 340° F. 20 minute bake), achieved a steel to aluminum lap shear peak stress of 32.59 MPa and 24.20 MPa after 21 day salt spray (74% property retention), an 8.97 N/mm T-Peel strength, a wedge impact peel strength at 23° C. of 28.43 N/mm, and a wedge impact peel strength at −40° C. of 8.14 N/mm. Example B's initial ambient lap shear strength after one hour was 1.14 MPa before the final baked cure. If considering Example I, with only a 0.25 MPa lap shear strength after one hour at ambient, a highly tough adhesive is achieved with a 12.21 N/mm T-Peel strength, a wedge impact peel strength at 23° C. of 43.46 N/mm, and a wedge impact peel strength at −40° C. of 30.39 N/mm. If considering a contrasting formula, Example J develops a very high 3.66 MPa lap shear after one hour at ambient and, after baking, a respectable 8.94 N/mm T-Peel strength, but only a steel to aluminum lap shear peak stress of 18.86 MPa, a wedge impact peel strength at 23° C. of 16.98 N/mm, and a wedge impact peel strength at −40° C. of 0.86 N/mm. There is a significant trade-off between the initial ambient lap shear strength and the final wedge impact strength. The final properties may vary widely depending on the curing package selection. Table 1 below lists the properties achieved with additional ingredient classes being used (Examples E-I) including ambient curing amines and phosphate esters (instead of mercaptans), acrylates, polyamides, and blocked isocyanate instead of dicyandiamide for latent curing. Compared to Example B, Example F with acrylates yielded improvements in T-Peel strength (9.49 N/mm) and wedge impact peel strength at 23° C. (33.27 N/mm), while Example E, with ambient amine instead of mercaptans, demonstrated the dual curing principle, comparing the one hour ambient lap shear to the final cured lap shear, but yielded less than desirable final properties. Example G demonstrates that phosphate ester can be used to build some initial ambient bond strength in one hour (0.31 MPa lap shear) and an increased (10.23 MPa) heat cured lap shear strength, but the final properties again are inferior to what has been achieved using amines or mercaptans to initiate the first stage of cure. Example H demonstrates that initial ambient bond strength can be achieved in one hour (0.44 MPa), while achieving desirable final properties using a blocked isocyanate latent hardener instead of dicyandiamide. FIGS. 14-17 show various results of the tests described above.

The dual-cure system's wash-off resistance is tested according to GMW16700 Method C using hot-dipped galvanized steel at 180 rpm for 3 minutes in 60° C. water. Examples B (11M,30), E (11M,30 A6) and F (13D,30) are each tested by running a 5-6 mm bead of material along the steel panel and then clamped to another panel with a 3 mm spacer. The wash-off test is performed immediately after application of the adhesive, as well as with new samples tested 1 hour after application to show the benefit of the dual-cure process. For the tests immediately run after adhesive application, about 90% of the material is washed off into the hot water bath. In contrast, the samples allowed to cure at ambient conditions for 1 hour before testing had no wash-off of material due to the advancement of the adhesive. This displays a key benefit of the dual-cure system in ensuring that the adhesive remains where it is applied, throughout washing steps, to later form the final strength bond in the second, typically heat-activated, curing process.

Lastly, the formulations described herein may be capable of being welded through shortly after material deposition because of its relatively low viscosity prior to advancement and its ability to be displaced by weld tips during a welding operation. In addition, the low viscosity of the formulation may minimize pillowing of mechanical fasteners for a more uniform bond line. Pillowing is described as the separation of substrates in between weld positions, with the greatest distortion midway between weld locations, with the effect being more pronounced as the viscosity of the uncured adhesive increases. This may be because the material has the ability to be displaced more easily and therefore enables the material to flow rather than causing bulging in between points where the two surfaces are brought into contact, either through welding or mechanical attachment.

Example formulations A-J are provided below.

### EXAMPLE (A): 11M,15—15% AMBIENT CURE PACKAGE WITH 4:1 VOLUME RATIO

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 21.50 |
| curing agent accelerator | 2.17 |
| epoxy hardener A | 17.38 |
| phenol curing agent | 36.44 |
| epoxy hardener B | 17.38 |
| polyetheramine | 5.13 |

### EXAMPLE (B): 11M,30—30% AMBIENT CURE PACKAGE WITH 4:1 VOLUME RATIO APPLICATION

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 13.53 |
| curing agent accelerator | 1.37 |
| epoxy hardener A | 26.55 |
| phenol curing agent | 27.84 |
| epoxy hardener B | 26.55 |
| polyetheramine | 4.16 |

### EXAMPLE (C): 11M,50—50% AMBIENT CURE PACKAGE WITH 2:1 VOLUME RATIO

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 7.35 |
| curing agent accelerator | 0.74 |
| epoxy hardener A | 33.66 |
| phenol curing agent | 21.19 |
| epoxy hardener B | 33.66 |
| polyetheramine | 3.40 |

### EXAMPLE (D): ONE-PART CORRESPONDING MATERIAL—11M,0

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 78.30 |
| curing agent accelerator | 7.92 |
| polyetheramine | 13.78 |

### EXAMPLE (E): 11M,30 A6—30% AMBIENT AMINE CURE PACKAGE WITH 4:1 VOLUME RATIO

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 22.09 |
| curing agent accelerator | 2.23 |
| ambient curing agent | 24.09 |
| phenol curing agent | 45.44 |
| polyetheramine | 6.15 |

### EXAMPLE (F): 13D,30—30% AMBIENT CURE PACKAGE WITH ACRYLATE ADDED TO PART A, 4:1 VOLUME RATIO APPLICATION

### Part A:

| Ingredient | Part A wt % |
|---|---|
| semi-solid epoxy resin | 3.81 |
| phenoxy resin dissolution | 8.50 |
| core shell toughening agent | 7.26 |
| (polybutadiene) | |
| core shell toughening agent | 5.39 |
| (styrene butadiene) | |
| silane-modified epoxy resin | 17.10 |
| bisphenol F epoxy resin | 32.05 |
| dicarboxylic acid epoxy adduct | 5.45 |
| epoxy adduct | 6.32 |
| polyurethane adduct and epoxy | 6.54 |
| CTBN liquid adduct | 4.96 |
| polyester urethane acrylate | 2.62 |

### Part B:

| Ingredient | Part B wt % |
|---|---|
| dicyanamide curing agent | 13.53 |
| curing agent accelerator | 1.37 |
| epoxy hardener A | 26.55 |
| phenol curing agent | 27.77 |
| epoxy hardener B | 26.55 |
| polyetheramine | 4.23 |

### EXAMPLE (G): 13Z,PE PHOSPHATE ESTER AMBIENT CURE PACKAGE, 5.95:1 MASS RATIO

### Part A:

| Ingredient | Part A wt % |
|---|---|
| semi-solid epoxy resin | 3.73 |
| phenoxy resin dissolution | 8.31 |
| core shell toughening agent | 7.10 |
| (polybutadiene) | |
| core shell toughening agent | 5.28 |
| (styrene butadiene) | |
| silane-modified epoxy resin | 16.74 |
| bisphenol F epoxy resin | 31.36 |
| dicarboxylic acid epoxy adduct | 5.33 |
| epoxy adduct | 6.18 |
| CTBN Liquid adduct | 4.86 |
| dicyanamide curing agent | 4.28 |
| curing agent accelerator | 0.43 |
| polyurethane adduct and epoxy | 6.40 |

### Part B:

| Ingredient | Part B wt % |
|---|---|
| phosphate ester | 100 |

### EXAMPLE (H): I-44 BLOCKED ISOCYANATE LATENT CURE PACKAGE IN PART A, 2:1 VOLUME RATIO APPLICATION

### Part A:

| Ingredient | Part A wt % |
|---|---|
| phenoxy resin dissolution | 6.21 |
| core shell toughening agent | 5.72 |
| (polybutadiene) | |
| core shell toughening agent | 4.16 |
| (styrene butadiene) | |
| silane-modified epoxy resin | 12.11 |
| bisphenol F epoxy resin | 41.59 |
| epoxy adduct | 2.31 |
| polyurethane resin | 4.61 |
| blocked isocyanate curing agent | 23.05 |
| silica | 0.23 |

### Part B:

| Ingredient | Part B wt % |
|---|---|
| epoxy hardener A | 97.48 |
| silica | 2.52 |

### EXAMPLE (I): 13H,30 WITH POLYAMIDE CURING AGENT IN PART B, 4:1 VOLUME RATIO APPLICATION

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 10.33 |
| curing agent accelerator | 1.04 |
| epoxy hardener A | 22.95 |
| phenol curing agent | 24.07 |
| epoxy hardener B | 22.95 |
| polyetheramine | 3.73 |
| polyamide curing agent | 14.92 |

### EXAMPLE (J): 17P WITH AMINE ADDUCT AND CHAIN EXTENDER—2:1 VOLUME RATIO

### Part A:

| Ingredient | Part A wt % |
|---|---|
| semi-solid epoxy resin | 3.92 |
| phenoxy resin dissolution | 8.73 |
| core shell toughening agent | 7.45 |
| (polybutadiene) | |
| core shell toughening agent | 5.54 |
| (styrene butadiene) | |
| silane-modified epoxy resin | 17.56 |
| bisphenol F epoxy resin | 32.91 |
| dicarboxylic acid epoxy adduct | 5.59 |
| epoxy adduct | 6.49 |
| polyurethane adduct and epoxy | 6.71 |
| CTBN liquid adduct | 5.10 |

### Part B:

| Ingredient | Part B wt % |
|---|---|
| dicyanamide curing agent | 5.26 |
| curing agent accelerator | 0.94 |
| epoxy hardener A | 15.23 |
| phenol curing agent | 18.19 |
| epoxy hardener B | 15.23 |
| polyetheramine | 2.52 |
| polyamide curing agent | 13.57 |
| epoxy chain extender | 13.84 |
| amine adduct | 13.29 |
| silica | 1.93 |

Examples E, F, G, H & I data for alternative ingredients, including ambient amine (11M,30 A6), acrylate (13D,30), phosphate ester (13Z,PE), blocked isocyanate (I-44), and polyamide (13H,30) respectively are shown below at Table 1:

TABLE 1

| | Exam- | Exam- | Exam- | Exam- | Exam- |
|---|---|---|---|---|---|
| Sample: | ple E | ple F | ple G | ple H | ple I |
| 1 h Ambient Lap Shear: | 0.48 | 0.66 | 0.31 | 0.44 | 0.25 |
| Peak Stress (MPa) at | | | | | |
| 50.8 mm/min | | | | | |
| Lap Shear: Peak Stress | 14.77 | 29.73 | 10.23 | 20.88 | 30.56 |
| (MPa) at 50.8 mm/min, | | | | | |
| EG-60 steel to 6061 Al | | | | | |
| T-Peel: Peel Strength | 2.96 | 9.49 | 1.74 | 10.60 | 12.21 |
| (N/mm) at 254 mm/min | | | | | |
| Wedge Impact, 23° C. at | | | | | |
| 2.000 m/s | | | | | |
| Average Peel (N/mm) | 2.00 | 33.27 | 0 | 32.26 | 43.46 |
| Energy (J) | 0.31 | 10.57 | 0 | 13.24 | 17.90 |

FIG. 1 shows maximum deflection due to coefficient of thermal expansion mismatch between 1″×12″ aluminum and steel coupons with exemplary adhesives and comparative adhesive located therebetween. Immediately after baking, the assembly is unclamped and allowed to bend freely as it cools. The maximum deflection is measured from the line drawn between the end points of the assembly (by placing it upside down on a flat surface) to the peak of the curve, as shown in the inset. The two analogous control samples and the Example D (11M,0) sample (with no ambient curing agent) show significantly greater deflection than the samples containing 15%, 30%, and 50% ambient curing agent.

FIG. 2 shows a bond line utilizing the exemplary adhesive of Example A (11M,15) (with 15% ambient curing agent and 30 minutes of ambient cure time before a 340° F. bake). No bond line separation is seen during the bake with solely the ends of the 12-inch assembly clamped.

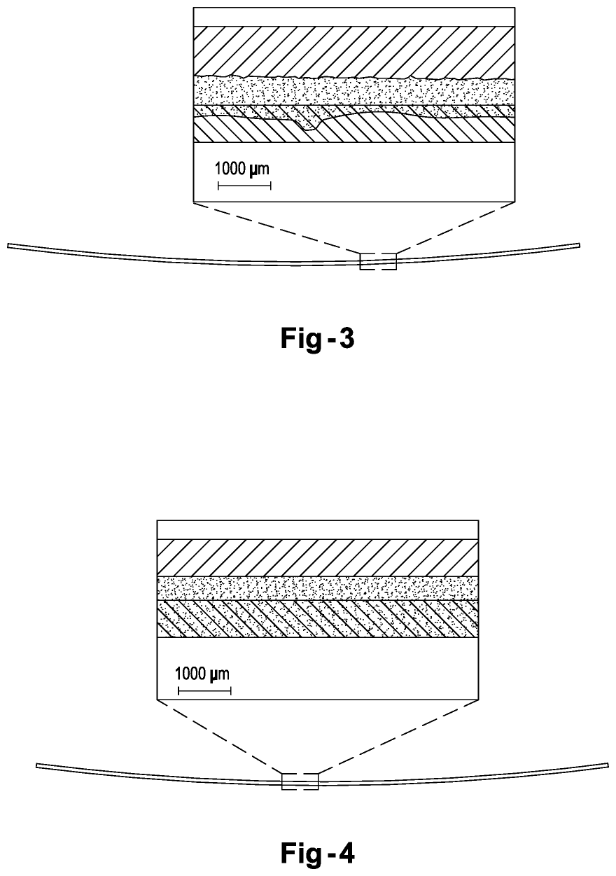

FIG. 3 shows a bond line utilizing the exemplary adhesive of Example A (11M,15) (with 15% ambient curing agent and 1 hour of ambient cure time before the 340° F. bake). No bond line separation is seen during the bake with solely the ends of the 12-inch assembly clamped.

FIG. 4 shows a bond line utilizing the exemplary adhesive of Example B (11M,30) (with 30% ambient curing agent and 30 minutes of ambient cure time before the 340° F. bake). No bond line separation is seen during the bake with solely the ends of the 12-inch assembly clamped.

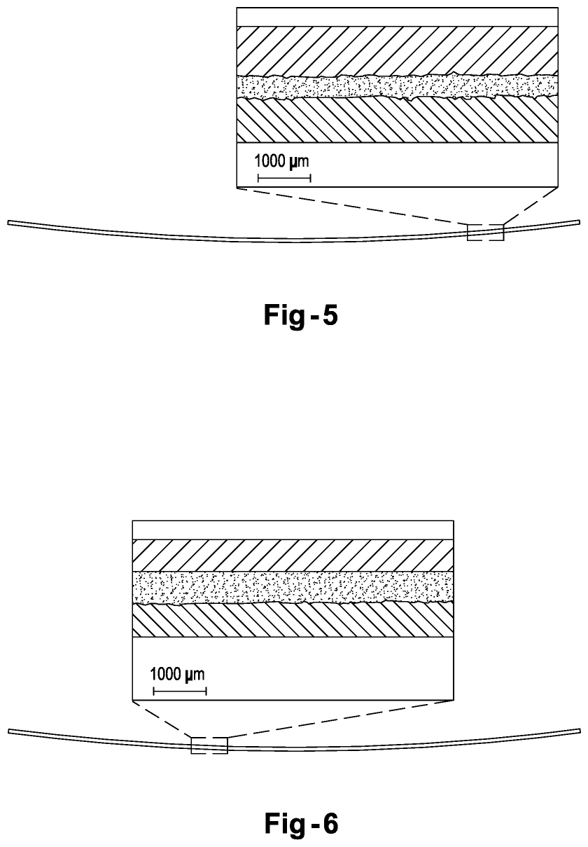

FIG. 5 shows a bond line utilizing the exemplary adhesive of Example B (11M,30) (with 30% ambient curing agent and 1 hour of ambient cure time before the 340° F. bake). No bond line separation is seen during the bake with solely the ends of the 12-inch assembly clamped.

FIG. 6 shows a bond line utilizing the exemplary adhesive of Example C (11M,50) (with 50% ambient curing agent and 30 minutes of ambient cure time before the 340° F. bake). No bond line separation is seen during the bake with solely the ends of the 12-inch assembly clamped.

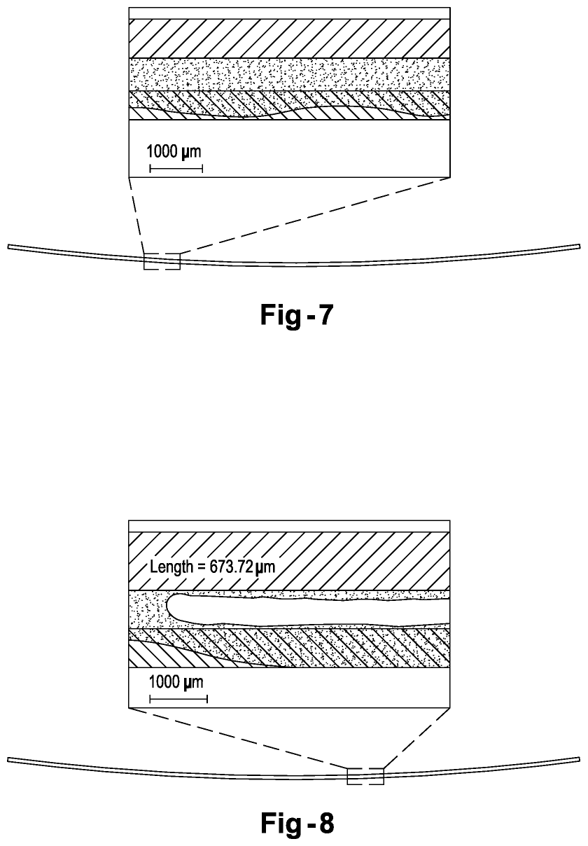

FIG. 7 shows a bond line utilizing the exemplary adhesive of Example C (11M,50) (with 50% ambient curing agent and 1 hour of ambient cure time before the 340° F. bake). No bond line separation is seen during the bake with solely the ends of the 12-inch assembly clamped.

FIG. 8 shows a bond line utilizing the exemplary adhesive of Example A (11M,15) (with 15% ambient curing agent and no ambient cure time before the 340° F. bake). Roughly half of the bond line shows separation.

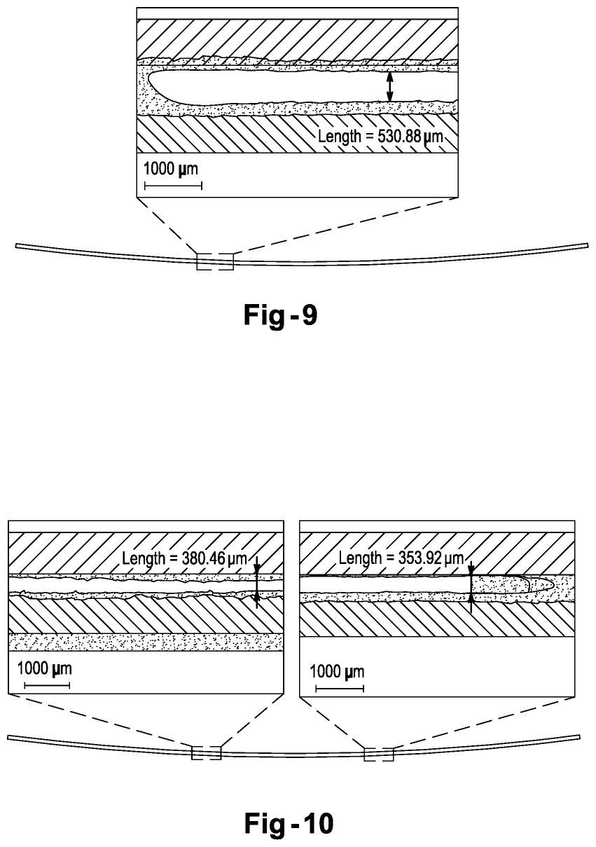

FIG. 9 shows a bond line utilizing the exemplary adhesive of Example B (11M,30) (with 30% ambient curing agent and no ambient cure time before the 340° F. bake). Roughly 40% of the bond line shows separation.

FIG. 10 shows a bond line utilizing the exemplary adhesive of Example C (11M,50) (with 50% ambient curing agent and no ambient cure time before the 340° F. bake). Roughly 25% of the bond line shows separation.

FIG. 11 shows a bond line utilizing a comparative formulation with no ambient curing agent after single-stage 340° F. bake. Roughly half of the bond line shows separation.

FIG. 12 shows a bond line utilizing a comparative formulation with no ambient curing agent after single-stage 340° F. bake. Roughly 40% of the bond line shows separation.

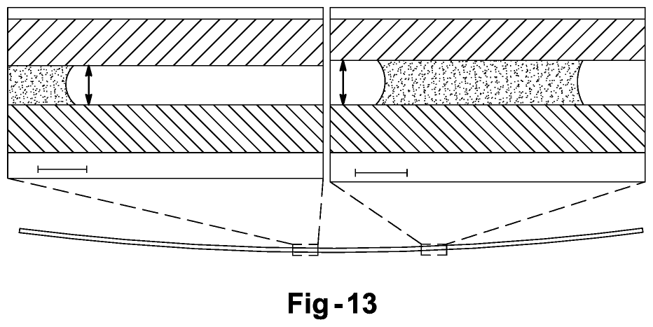

FIG. 13 shows a bond line comparative formulation of Example D (11M,0) with all the ambient curing package removed. About a third of the bond line shows separation after the 340° F. bake.

FIG. 14 shows green state (prior to secondary cure) lap shear strength of an exemplary adhesives between EG-60 steel and 6061 aluminum (50.8 mm/min rate) after minutes, 1 hour, 2 hour, and 2 days of ambient cure time for 15%, 30%, and 50% ambient cure packages.

FIG. 15 shows exemplary adhesive T-peel data at 254 mm/min (EZG-60 substrate) for various ambient cure times before baking and 15%, 30%, and 50% ambient curing agent loadings.

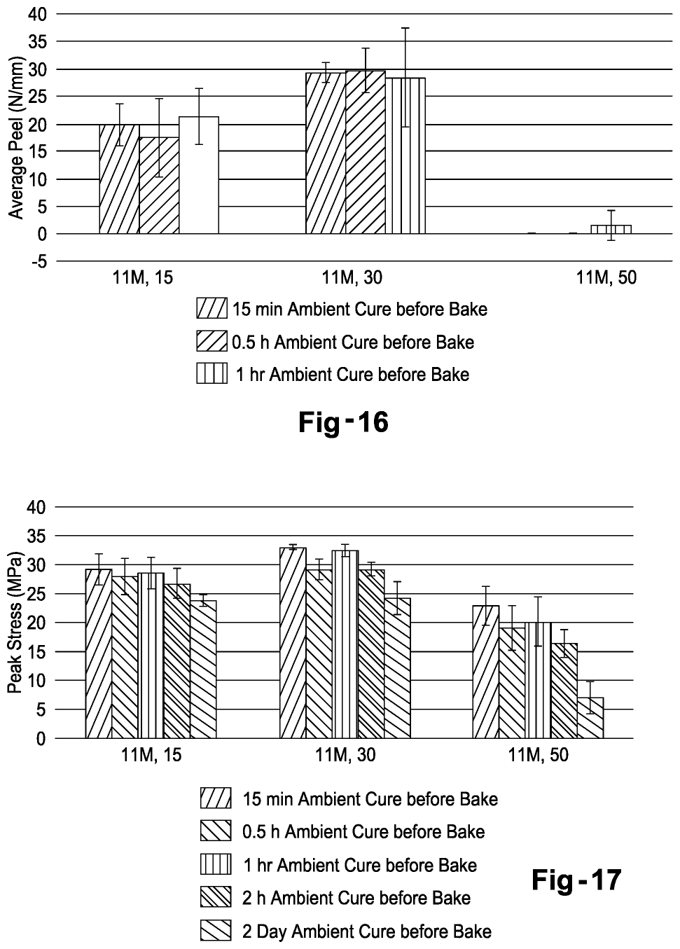

FIG. 16 shows exemplary adhesive wedge impact testing at 2.000 m/s and 23° C. on EZG-60, for various ambient cure times before baking and 15%, 30%, and 50% ambient curing agent loadings. Excessive ambient curing agent (50% here) causes embrittlement of the final baked material.

FIG. 17 shows exemplary adhesive lap shear testing on EG-60 steel to 6061 aluminum (50.8 mm/min rate) for various ambient cure times before baking and 15%, 30%, and 50% ambient curing agent loadings.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “x parts by weight of the resulting polymeric blend composition” also contemplates a teaching of ranges of same recited amount of “x in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consists of, the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It will be appreciated that concentrates or dilutions of the amounts recited herein may be employed. In general, the relative proportions of the ingredients recited will remain the same. Thus, by way of example, if the teachings call for 30 parts by weight of a Component A, and 10 parts by weight of a Component B, the skilled artisan will recognize that such teachings also constitute a teaching of the use of Component A and Component B in a relative ratio of 3:1. Teachings of concentrations in the examples may be varied within about 25% (or higher) of the stated values and similar results are expected. Moreover, such compositions of the examples may be employed successfully in the present methods.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not It is understood that the above description is intended to be illustrative and not restrictive. Many embodiments as well as many applications besides the examples provided will be apparent to those of skill in the art upon reading the above description.

The explanations and illustrations presented herein are intended to acquaint others skilled in the art with the invention, its principles, and its practical application. Those skilled in the art may adapt and apply the teachings in their numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1. A two-component dual-cure adhesive having a first component and a second component that partially react when mixed to provide some adhesive strength plus processing capability and further reacts upon exposure to a secondary stimulus to produce a high strength adhesive.

2. The adhesive of claim 1, wherein the secondary stimulus is heat.

3. The adhesive of claim 1, wherein only one of the first or second component includes only one type of a reactive group to react with an ambient curative and a latent curative.

4. The adhesive of claim 2, wherein both first and second components include complementary reactive species.

5. The adhesive of claim 3, wherein the first component and second component include reactive species that form an interpenetrating network (IPN).

6. The adhesive of claim 1, wherein the first component includes an epoxy and the second component includes one or more of an amine, an amine derivative, a polyamide, an anhydride, a phenol, an imidazole, a phosphate ester or phosphoric acid, a mercaptan, or a mercaptan derivative.

7. The adhesive of claim 6, wherein at least one of the first or second component includes two or more reactive groups to react with both an ambient curative and a latent curative.

8. The adhesive of claim 2, wherein the first component comprises both epoxy and acrylate and the second component includes one or more of an amine, an amine derivative, a polyamide, an anhydride, a phenol, an imidazole, a phosphate ester or phosphoric acid, a mercaptan, or a mercaptan derivative.

9. The adhesive of claim 8, wherein an ambient curative forms a thermoplastic after mixing the first and second components.

10. The adhesive of claim 1, wherein an ambient curative forms a partial thermoset after mixing the first and second components.

11. The adhesive of claim 6, wherein a latent curative forms a thermoplastic after exposing the adhesive to a stimulus.

12. The adhesive of claim 6, wherein a latent curative forms a thermoset after exposing the adhesive to a stimulus.

13. The adhesive of claim 1, wherein the addition of an ambient curing agent decreases the level of warping or deflection in final bonded dissimilar substrates after exposure to a stimulus due to coefficient of thermal expansion mismatch.

14. The adhesive of claim 1, wherein increasing levels of an ambient curing agent in the cure package decreases warpage of the final bonded dissimilar substrates.

15. The adhesive of claim 6, wherein the dual cure of the adhesive substantially prevents bond line separation of dissimilar substrates if allowed to remain at room temperature prior to exposure to a stimulus.

16. The adhesive of claim 14, wherein increasing levels of an ambient cure fraction increase a developed green state lap shear strength and also increases the holding ability, to minimize the number of fasteners required to hold a part in position pre-cure.

17. The adhesive of claim 15, wherein a first-stage, ambient cure must not react to a degree such that it prevents proper wet out and/or complete cure.

18. The adhesive of claim 3, wherein there is an optimum percentage of ambient curing agent between 5 and 50%, or even between 15-30%, of the total cure equivalents to fully react the adhesive.

19. The adhesive of claim 1, wherein an amount of ambient curing agent below about 5% substantially prevents one or more adhesive properties from developing.

20. The adhesive of claim 1, wherein an amount of ambient curing agent above about 50% has a deleterious effect on one or more adhesive properties.

21. (canceled)
